(19) United States
(12) Patent Application Publication
(10) Pub. No.: US 2025/0364749 A1
(43) Pub. Date: Nov. 27, 2025

(54) CONNECTOR

(71) Applicant: Giga Computing Technology Co., Ltd., New Taipei City (TW)

(72) Inventors: Tung-Lin Tsai, New Taipei City (TW); Chia-Neng Yang, New Taipei City (TW); Ching-Chuan Huang, New Taipei City (TW); Shao-Wei Hsiao, New Taipei City (TW); Chuang-Pan Tai, New Taipei City (TW)

(73) Assignee: Giga Computing Technology Co., Ltd., New Taipei City (TW)

(21) Appl. No.: 18/797,519

(22) Filed: Aug. 8, 2024

(30) Foreign Application Priority Data
May 27, 2024 (TW) 113119468

(51) Int. Cl. H01R 13/46

(52) U.S. Cl. CPC H01R 13/46

(57) ABSTRACT

A connector including a main body, a connecting element and at least one reinforcing element is provided. The main body includes a connecting portion. The connecting element is connected to the main body, and the connecting element surrounds the connecting portion to form a connecting opening. The connecting element includes an inner surface facing the connecting portion. At least one reinforcing element is connected to the inner surface of the connecting element and extends along a plugging direction of the connecting portion.

### CROSS-REFERENCE TO RELATED APPLICATION

This application claims the priority benefit of Taiwan application serial no. 113119468, filed on May 27, 2024. The entirety of the above-mentioned patent application is hereby incorporated by reference herein and made a part of this specification.

### BACKGROUND

### Technical Field

The disclosure relates to a connector.

### Description of Related Art

The modern server includes a circuit board, a plurality of connectors and a plurality of signal wires. The signal wires are connected to the connectors, and the connectors are plugged into the circuit board to electrically connect the signal wires to the circuit board for a high-speed signal transmission. The connectors used for the high-speed signal transmission are easily loosened due to shaking, impact or unexpected external force, which makes the connectors unable to be stably connected to the circuit board, resulting in signal instability, instantaneous interruption or poor performance.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

A connector, which for stable connection, is provided in the disclosure.

The other objectives and advantages of the disclosure may be further understood from the descriptive features disclosed in the disclosure.

In order to achieve one of, or portions of, or all of the above objectives or other objectives, the connector includes a main body, a connecting element and at least one reinforcing element. The main body includes a connecting portion. The connecting element is connected to the main body, and the connecting element surrounds the connecting portion to form a connecting opening. The connecting element includes an inner surface facing the connecting portion. At least one reinforcing element is connected to the inner surface of the connecting element and extends along a plugging direction of the connecting portion.

Based on the above, the connecting element of the connector of the disclosure surrounds the connecting portion of the main body, so that the connecting portion may be stably connected to a corresponding external connection port. The reinforcing element is connected to the connecting element and is used to improve a connection stability of the connecting portion.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a connector connected to a connection port according to an embodiment of the disclosure.

FIG. 2 is a schematic diagram of the connector of FIG. 1.

FIG. 3 is a cross-sectional view of the connector and the connection port of FIG. 1.

FIG. 4 is a schematic diagram of a connector according to an embodiment of the disclosure.

FIG. 5 is a schematic diagram of a connector according to an embodiment of the disclosure.

FIG. 6 is a schematic diagram of a connector according to an embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

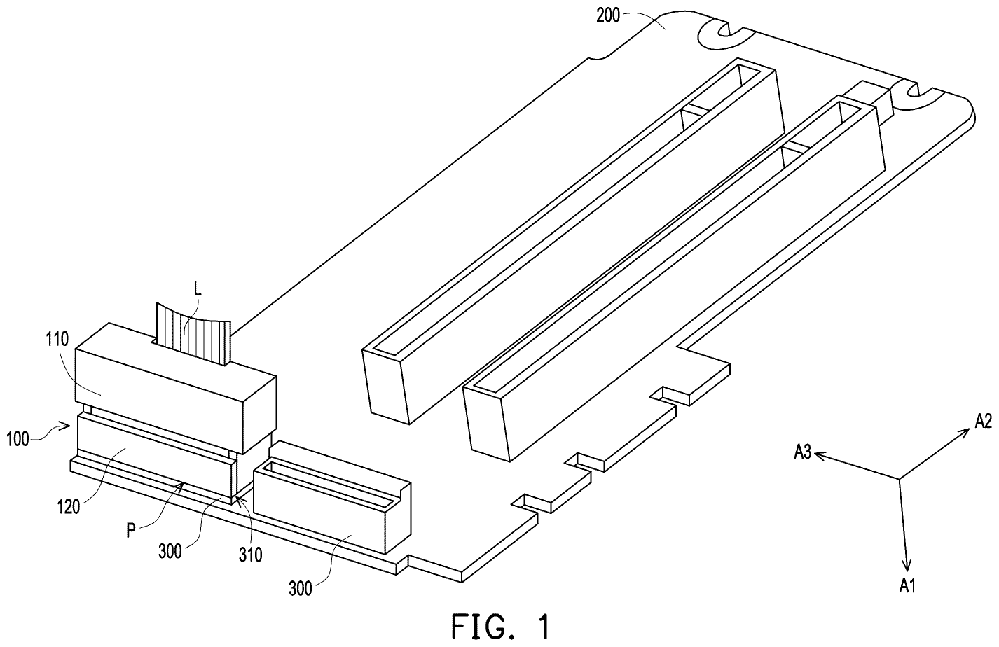

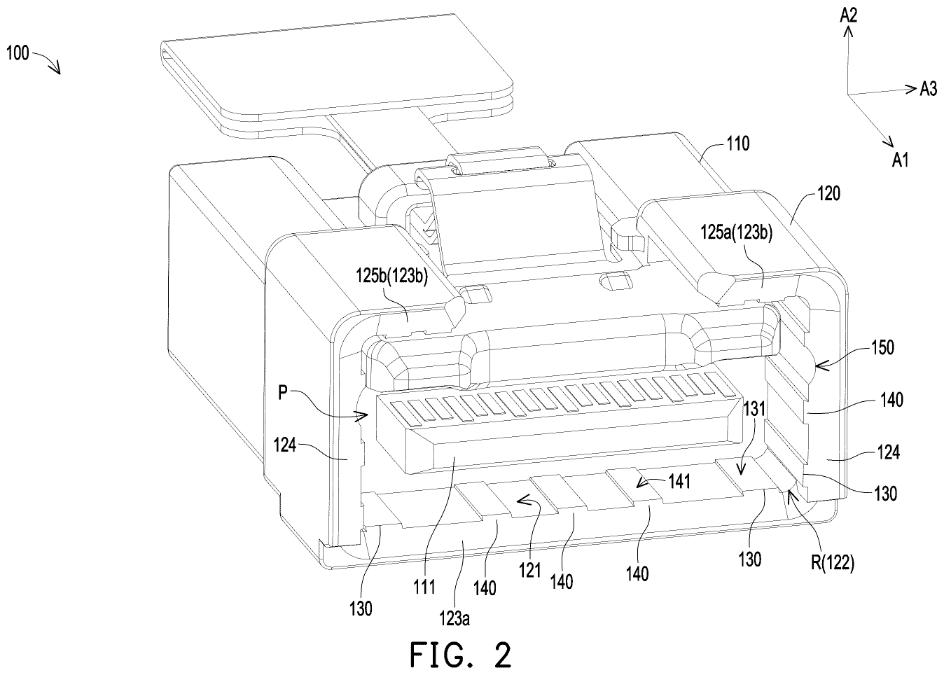

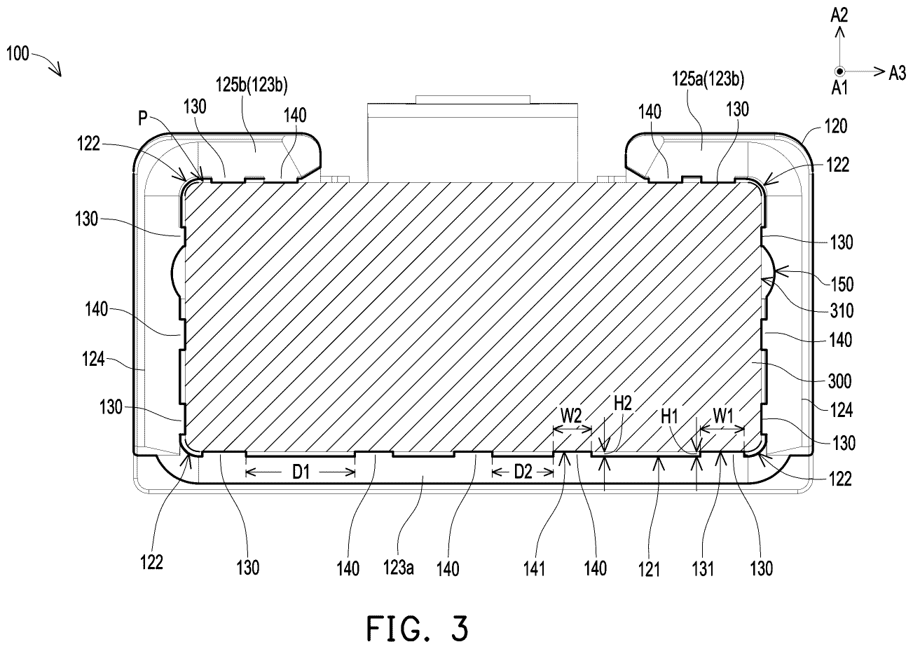

FIG. 1 is a schematic diagram of a connector connected to a connection port according to an embodiment of the disclosure. FIG. 2 is a schematic diagram of the connector of FIG. 1. FIG. 3 is a cross-sectional view of the connector and the connection port of FIG. 1. A coordinate formed by a plugging direction A1, a first direction A2 and a second direction A2 is provided here to facilitate component description. The first direction A2 is perpendicular to the plugging direction A1 and the second direction A3, and the second direction A3 is perpendicular to the plugging direction A1. Referring to FIG. 1 to FIG. 3, the connector 100 includes a main body 110, a connecting element 120 and at least one reinforcing element 130. The main body 110 includes a connecting portion 111. The connecting element 120 is connected to the main body 110. The connecting element 120 includes an inner surface 121, the inner surface 121 faces the connecting portion 111. The connecting element 120 surrounds the connecting portion 111 to form a connecting opening P. The at least one reinforcing element 130 is connected to the inner surface 121 of the connecting element 120, and extends along the plugging direction A1 of the connecting portion 111. The connector 100 further includes a transmission wire L, the transmission wire L is connected to the main body 110. The connecting portion 111 of the connector 100 may be connected to a connection port 300 of a circuit board 200, so that the connector 100 (the transmission wire L) and the circuit board 200 are electrically connected. The connector 100 of this embodiment is a MCIO connector with 38 pins, the connector 100 is used for a high-speed signal transmission, but is not limited thereto.

As shown in FIG. 2 and FIG. 3, when the connector 100 is connected to the connection port 300, a top surface 131 of the reinforcing element 130 of the connector 100 abuts against a surface 310 of the connection port 300 to provide a friction force, and the connecting element 120 surrounds the connection port 300. The known MCIO connector only relies on the connecting portion to connect to the connection port 300. When the known MCIO connector is subjected to an unexpected external force, the known MCIO connector is prone to loosening, resulting in signal instability. In this embodiment, when the connector 100 is subjected to the unexpected external forces such as a shaking and a impact, the connector 100 is stably connected to the connection port 300 through the friction force provided by the reinforcing element 130, thereby preventing the connector 100 from being unexpected removed from the connection port 300 (the circuit board 200). The connection port 300 is located in the connection opening P on all sides and is surrounded by the connector 120 to enhance a tensile strength of the connector 100 along the first direction A2 and the second direction A3. Thereby, a connection strength between the connector 100 and the connection port 300 is increased and the tensile strength is enhanced, which may prevent the connector 100 from loosening due to the unexpected force and being disconnected from the connection port 300.

The connecting element 120 includes at least one first region, at least one second region and at least one bend area, and the bend area is connected to the first region and the second region. The reinforcing element 130 is located on at least one side of the bend area. Specifically, the connecting element 120 of this embodiment includes two first regions 124, two second regions 123a, 123b and four bend areas 122. Each bend area 122 has a rounded corner R. The two first regions 124 are opposite to each other, the two second regions 123a, 123b are opposite to each other, and the four bend areas 122 are respectively connected to the corresponding two second regions 123a, 123b and the two first regions 124. The two first regions 124 are extend along the first direction A2, and the two second regions 123a and 123b are extend along the second direction A3. Specifically, the second region 123b includes two parts 125a, 125b separated from each other. The two parts 125a, 125b are respectively connected to the corresponding two first regions 124 through the two corresponding bend areas 122, so that the connecting element 120 forms a C-shaped. The connecting element 120 and the main body 110 may be integrally formed, and the material may be a plastic, but is not limited thereto.

As shown in FIG. 3, the number of the reinforcing element 130 corresponds to the number of bend area 122 and is eight. The eight reinforcing elements 130 are located in pairs on the two sides of the four bend areas 122, and is located on the two second regions 123a, 123b and the two first regions 124. Thereby, a stability of the connecting element 120 of the connector 100 may be improved, so that the connecting element 120 is stably connected to the connection port 300 without deformation. A thickness H1 of each of the reinforcing members 130 in a direction perpendicular to the plugging direction A1 is 0.1 mm. That is, a distance between the inner surface 121 and the top surface 131 of the reinforcing element 130 is 0.1 mm. Thereby, an assembly tolerance between the connector 100 and the connection port 300 may be absorbed by the reinforcing elements 130, so that the connector 100 is stably contacted to the connection port 300 through the reinforcing elements 130.

As shown in FIG. 2 and FIG. 3, the connector 100 further includes at least one auxiliary reinforcing element 140. The auxiliary reinforcing element 140 is connected to the inner surface 121 of the connecting element 120 and extends along the plugging direction A1. There is a distance D1 between the auxiliary reinforcing element 140 and the reinforcing element 130. The three auxiliary reinforcing elements 140 located in the second region 123a have a distance D2 between each other. The distance D2 is, for example, 1.6 mm, but is not limited thereto. The distance D2 is smaller than the distance D1. The auxiliary reinforcing element 140 may be located in the second regions 123a, 123b and the first regions 124. The number of the auxiliary reinforcing element 140 of this embodiment is seven, but is not limited thereto. The three auxiliary reinforcing elements 140 are located in the second region 123a, and the two auxiliary reinforcing elements 140 are respectively located in the two parts 125a, 125b of the second region 123b. The two auxiliary reinforcing elements 140 are respectively located in the two first regions 124. A thickness H2 of each of the auxiliary reinforcing elements 140 in the direction perpendicular to the plugging direction A1 is 0.1 mm, that is, a distance between the inner surface 121 and a surface 141 of the auxiliary reinforcing element 140 is 0.1 mm, so that the assembly tolerance between the connector 100 and the connection port 300 is absorbed by the auxiliary reinforcing elements 140.

When the connector 100 is connected to the connection port 300, in addition to the top surfaces 131 of the reinforcing elements 130, the surface 141 of each of the auxiliary reinforcements 140 also abuts against the connection port 300. The increase in a contact area between the connector 100 and the connection port 300 (ie, the top surfaces 131 of the reinforcing elements 130 and the surfaces 141 of the auxiliary reinforcing elements 140) enhances the friction force between the connector 100 and the connection port 300, and enhances the stability between the connector 100 and the connection port 300. The connector 100 adjusts the friction force by adjusting the contact area (top surfaces 131 and surfaces 141) with the connection port 300 to maintain the friction force within a specific range. Thereby, the connection strength between the connector 100 and the connection port 300 is increased and the tensile strength is appropriately enhanced, so that the connector 100 is easily pulled in an opposite direction of the plugging direction A1 to enhance the convenience of assembly between the connector 100 and the connection port 300.

As shown in FIG. 2 and FIG. 3, a ratio of a width W1 of the reinforcing element 130 in the direction perpendicular to the plugging direction A1 to a width W2 of the reinforcing element 140 in the direction perpendicular to the insertion direction A1 located in the same regions (ie, the second regions 123a, 123b and the first regions 124) may be between 1 and 1.5, but is not limited thereto. The ratio of the width W1 to the width W2 is preferably 1.2. Specifically, the width W1 of this embodiment is larger than the width W2. The width W1 of the reinforcing element 130 is, for example, 1 mm, but is not limited thereto. The width W1 of each of reinforcing elements 130 and the width of each of the auxiliary reinforcing elements 140 located in the different regions may be different, and the distance between the auxiliary reinforcing elements 140 and the reinforcing elements 130 located in the different regions may be different.

For example, in this embodiment, the width of the reinforcing element 140 located in the first region 124 is smaller than the width of the auxiliary reinforcing element 140 located in the second region 123b (the parts 125a, 126b). The width of the auxiliary reinforcing element 140 located in the second region 123b is smaller than the width W2 of the auxiliary reinforcing element 140 located in the second region 123a. The width of the reinforcing element 130 located in the first region 124 is smaller than the width of the reinforcing element 130 located in the second region 123b. The width of the reinforcing element 130 located in the second region 123b is smaller than the width W2 of the reinforcing element 130 located in the second region 123a.

The distance between the auxiliary reinforcing element 140 and the reinforcing element 130 located in the second region 123b is smaller than the distance between the auxiliary reinforcing element 140 and the reinforcing element 130 located in the first region 124. The distance between the auxiliary reinforcing element 140 and the reinforcing element 130 located in the first region 124 is smaller than the distance D1 between the auxiliary reinforcing element 140 and the reinforcing element 130 located in the second region 123a.

As shown in FIG. 2 and FIG. 3, the connector 100 further includes at least one recess 150. The recess 150 is disposed on the connecting element 120 and connected to the auxiliary reinforcing element 140 or the reinforcing element 130. The number of the at least one recess 150 of this embodiment is two, the two recesses 150 are respectively located in the two first regions 124, and the recesses 150 are connected to the reinforcing elements 130, but are not limited thereto. The recess 150 is located between the reinforcing element 130 and the auxiliary reinforcing element 140. The recess 150 is specifically an arc-shaped groove recessed from the inner surface 121 of the connecting element 120 to enhance a structural stability of the reinforcing element 130 through the arc structure, thereby preventing the connector 100 from loosening due to repeated plug and unplug.

According to a standard of SFF-TA-1016, the maximum tensile strength of the MCIO connector needs to be 25 Newtons (N). Through disposing the connecting element 120, the reinforcing elements 130, the auxiliary reinforcing elements 140 and the recesses 150, the tensile strength of the connector 100 of this embodiment along the plugging direction A1, the first direction A2 and the second direction A3 is 37 N. Compared to the known MCIO connector, the connector 100 of this embodiment is connected to the connection port 300 more stably.

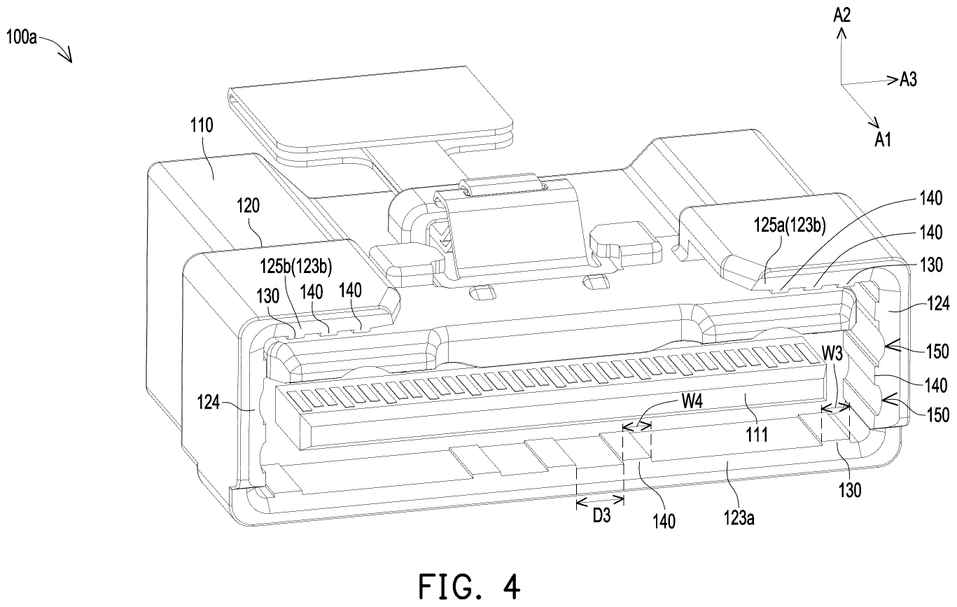

FIG. 4 is a schematic diagram of a connector according to an embodiment of the disclosure. Referring to FIG. 2 and FIG. 4 at the same time, the connector 100a of this embodiment is similar to the previous embodiment. The difference between the two is that the connector 100a of this embodiment is a MCIO connector with 72 pins. The number of the auxiliary reinforcing element 140 is nine. The two auxiliary reinforcing elements 140 are located in the part 125a of the second region 123b, the two auxiliary reinforcing elements 140 are located in the part 125b of the second region 123b, the three auxiliary reinforcing elements 140 are located in the second region 123a, and the two auxiliary reinforcing elements 140 are located in the two first regions 124 respectively. The number of the recess 150 is four, and the four recesses 150 are located in the two first regions 124 in pairs. The two recesses 150 are connected to two sides of the corresponding auxiliary reinforcing element 140. The width W3 of the reinforcing element 130 in the direction perpendicular to the plugging direction A1 is equal to the width W4 of the auxiliary reinforcing element 140 in the direction perpendicular to the insertion direction A1. The width W3 is, for example, 1.2 mm, but is not limited thereto. The distance D3 between the two auxiliary reinforcing elements 140 located in the second region 123a is, for example, 2 mm, but is not limited thereto. The connector 100a of this embodiment has the same effect as the previous embodiment, and is not repeated herein.

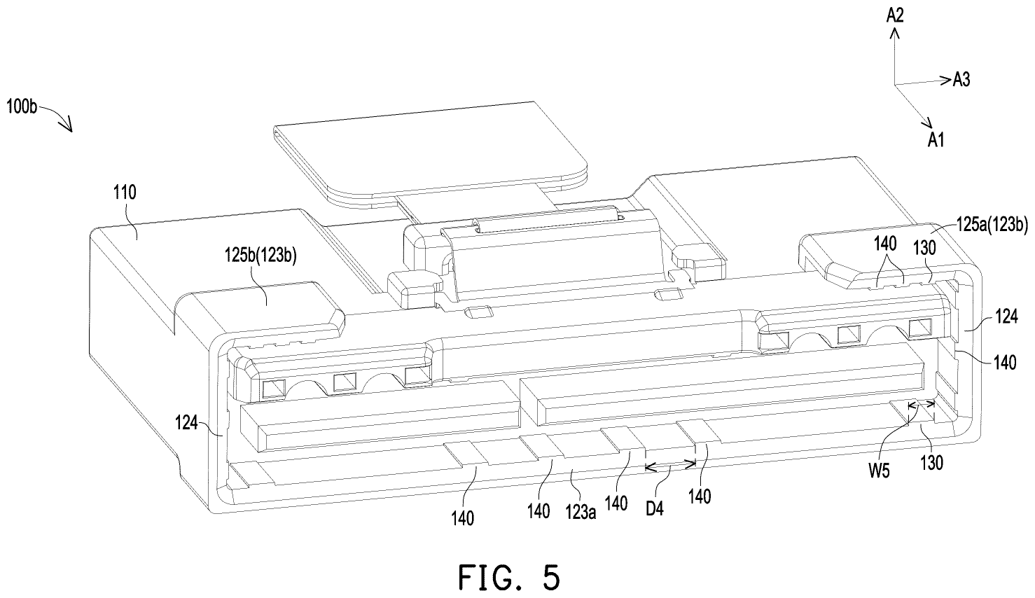

FIG. 5 is a schematic diagram of a connector according to an embodiment of the disclosure. Referring to FIG. 2 and FIG. 5 at the same time, the connector 100b of this embodiment is similar to the previous embodiment. The difference between the two is that the connector 100b of this embodiment is a MCIO connector with 124 pins. The number of the auxiliary reinforcing element 140 is ten. The four auxiliary reinforcing elements 140 are located in the second region 123a, the two auxiliary reinforcing elements 140 are located in the part 125a of the second region 123b, the two auxiliary reinforcing elements 140 are located in the part 125b of the second region 123b, and the two auxiliary reinforcing elements 140 are located in the two first regions 124 respectively. The width W5 of the reinforcing element 130 is, for example, 1.5 mm, but is not limited thereto. The distance D4 between the two auxiliary reinforcing elements 140 located in the second region 123a is, for example, 3 mm, but is not limited thereto. The connector 100b of this embodiment has the same effect as the previous embodiment, and is not repeated herein.

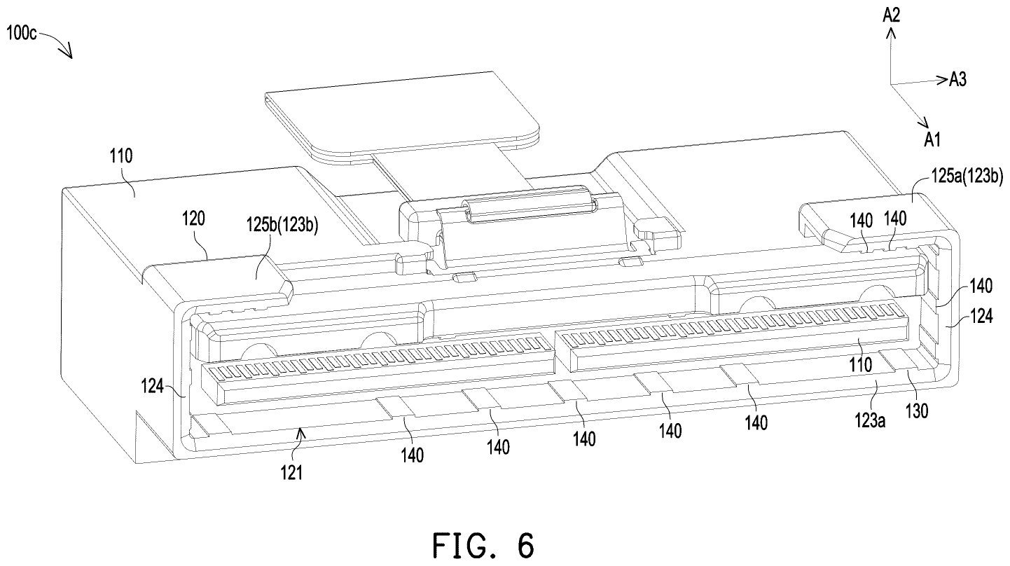

FIG. 6 is a schematic diagram of a connector according to an embodiment of the disclosure. Referring to FIG. 2 and FIG. 6 at the same time, the connector 100c of this embodiment is similar to the previous embodiment. The difference between the two is that the connector 100c of this embodiment is a MCIO connector with 148 pins. The number of the auxiliary reinforcing element 140 is twelve. The five auxiliary reinforcing elements 140 are located in the second region 123a, the two auxiliary reinforcing elements 140 are located in the part 125a of the second region 123b, the two auxiliary reinforcing elements 140 are located in the part 125b of the second region 123b, and the two auxiliary reinforcing elements 140 are located in the two first regions 124 respectively. The connector 100c of this embodiment has the same effect as the previous embodiment, and is not repeated herein.

It can be seen that the number of the auxiliary reinforcing element 140 is changed according to the specifications of the connectors 100, 100a, 100b, 100c, so as to adjust the friction force between the connector 100, 100a, 100b, 100c and the connection port 300 through the reinforcing elements 130 and the auxiliary reinforcing elements 140, makes the connector 100, 100a, 100b, 100c may be easy to plug and unplug, thereby improving the convenience of use of the connector 100, 100a, 100b, 100c.

To sum up, the connecting element of the connector of the disclosure surrounds the connecting portion of the main body, so that the connecting portion may be stably connected to a corresponding external connection port. The reinforcing element is connected to the connecting element and is used to improve a connection stability of the connecting portion.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A connector, comprising:
a main body, comprising a connecting portion;
a connecting element, connected to the main body, the connecting element surrounds the connecting portion to form a connecting opening, the connecting element comprises an inner surface, the inner surface faces the connecting portion; and
at least one reinforcing element, connected to the inner surface of the connecting element and extends along a plugging direction of the connecting portion.

2. The connector according to claim 1, wherein the connecting element comprises at least one bend area, the at least one reinforcing element is located on at least one side of the at least one bend area.

3. The connector according to claim 1, wherein the connecting element comprises four bend areas, the number of the at least one reinforcing element is eight, the eight reinforcing elements are located in pairs on two sides of the four bend areas.

4. The connector according to claim 1, a thickness of each of the at least one reinforcing element in a direction perpendicular to the plugging direction is 0.1 mm.

5. The connector according to claim 1, further comprises at least one auxiliary reinforcing element, the at least one auxiliary reinforcing element is connected to the inner surface and extended along the plugging direction, there is a distance between the at least one auxiliary reinforcing element and the at least one reinforcing element.

6. The connector according to claim 5, a thickness of each of the at least one auxiliary reinforcing element in a direction perpendicular to the plugging direction is 0.1 mm.

7. The connector according to claim 5, a width of each of the at least one reinforcing element in a direction perpendicular to the plugging direction is larger than a width of each of the at least one auxiliary reinforcing element in the direction perpendicular to the plugging direction.

8. The connector according to claim 5, a width of each of the at least one reinforcing element in a direction perpendicular to the plugging direction is equal to a width of each of the at least one auxiliary reinforcing element in the direction perpendicular to the plugging direction.

9. The connector according to claim 5, further comprises at least one recess, the at least one recess is disposed on the connecting element and connected to the at least one auxiliary reinforcing element.

10. The connector according to claim 1, further comprises at least one recess, the at least one recess is disposed on the connecting element and connected to the at least one reinforcing element.

11. The connector according to claim 1, further comprises a transmission wire, the transmission wire is connected to the main body.

12. The connector according to claim 1, wherein the connecting element comprises two first regions, two second regions and four bend areas, the two first regions are opposite to each other, the two second regions are opposite to each other, and the four bend areas are respectively connected to corresponding each of the two first regions and each of the two second regions, the two first regions extend along a first direction, the two second regions extend along a second direction, the first direction is perpendicular to the plugging direction and the second direction, the second direction is perpendicular to the plugging direction.
